(19) United States
(12) Patent Application Publication
(10) Pub. No.: US 2018/0247564 A1
(43) Pub. Date: Aug. 30, 2018

(54) Potty Training Device with Interchangeable Themes

(71) Applicant: S. K. Decker, Mill Valley, CA (US)

(72) Inventor: S. K. Decker, Mill Valley, CA (US)

(21) Appl. No.: 15/443,224

(22) Filed: Feb. 27, 2017

(51) Int. Cl. G09B 19/00; A47K 11/06; A47K 11/04

(52) U.S. Cl. CPC G09B 19/0076; A47K 11/04; A47K 11/06

(57) ABSTRACT

A potty training device with interchangeable themes that includes a standard potty seat, a potty lid, a removable and replaceable open topped container, a themed front portion that removably attaches to the open topped container, a book holding pocket, and a removable and replaceable themed graphic panel shaped to fit the inner wall of the potty lid. A preferred embodiment, within the themed front portion, an audio device is installed that can be operated by the user and can be programmed emit a sound that corresponds with the theme of the potty training device.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of potty training devices and more specifically to a potty training device with interchangeable themes.

Potty training devices are well known. They are used to help train toddlers how to urinate and defecate in a toilet type structure. The potty device is a scaled down version of an adult toilet.

Some potty training devices have been designed around a theme. For example, Freddie R. Roberts et al in his U.S. Pat. No. 4,883,749 discloses a potty chair whose back panel is in the shape of a playful dog and side arms are in the shape of dog bones.

However, there is a deficiency in the prior technology in that it is not possible to easily change themes from one subject matter to another. The biggest obstacle facing parents is the loss of interest by the toddler. Therefore, if a parent wanted to purchase a potty chair with a different theme, they would have to purchase a completely new potty chair, thereby adding additional expense and bulkiness to the process. The current invention provides a less expensive option, with themes and novel stories to accompany the new theme. It is both a reward system for the toddler as well as a way to keep them engaged in the potty training process.

### BRIEF SUMMARY OF THE INVENTION

The primary object of the invention is to provide a potty training device that includes removable and replaceable components so that the device can transform to different themed subjects such as a train, plane or rocket ship.

Another object of the invention is to provide a themed potty training device that includes a pocket for a story book that corresponds with the theme of the potty chair.

Yet another object of the invention is to provide a themed potty training device that includes a preprogrammed audio sound device that, when activated by the user, produces a sound that corresponds to the theme of the chair.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed potty training device with interchangeable themes comprising: a standard potty seat, a potty lid, a removable and replaceable open topped container, a themed front portion that removably attaches to said open topped container, a book holding pocket, and a removable and replaceable themed graphic panel shaped to fit the inner wall of said potty lid.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of a train theme of the present invention.

FIG. 2 is an exploded view of the train theme of the present invention.

FIG. 3 is a perspective view of an elephant theme of the present invention.

FIG. 4 is a perspective view of a vehicle theme of the present invention.

FIG. 5 is a perspective view of a rocket theme of the present invention.

FIG. 6 is a rear view of the present invention showing the book pocket of the present invention.

FIG. 7 is an exploded view showing how the front themed panel attaches to the open topped container.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

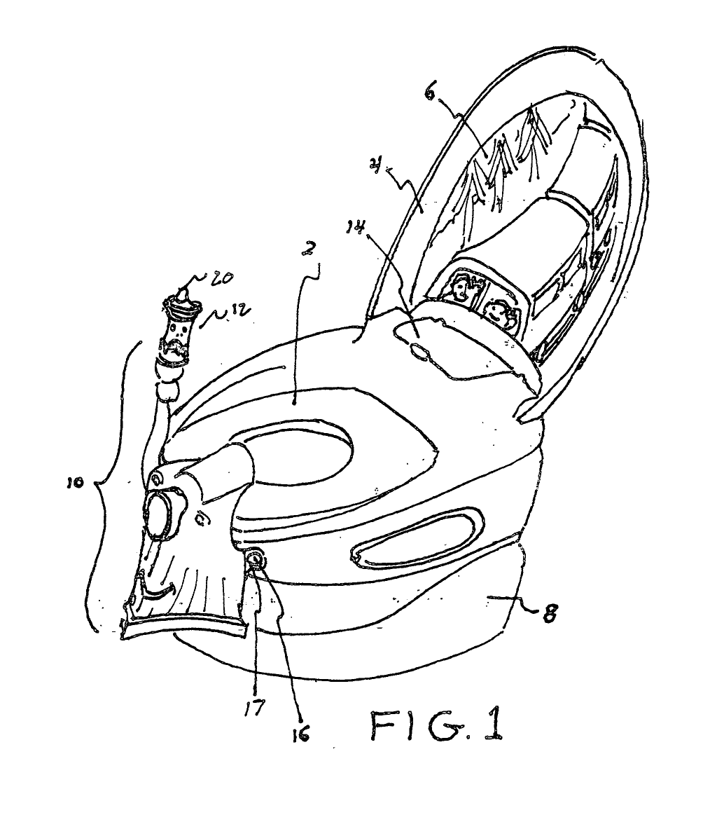

Referring now to FIG. 1 we see a perspective view of the potty chair of the present invention that includes a standard potty base portion 8 and seat 2 as well as a hinged lid 4. A secondary lid 14 conceals a space for wipes. The lid 4 includes a removable graphic panel 6 that is retained with Velcro or other standard attachment means. A themed front portion 10 is in the shape of the front of a train engine and includes a whistle 12 that emits a whistle sound when the user presses on the top button 20. Audio electronics on the inside of the whistle 12 cause the sound to be emitted. The front themed portion 10 is removably attached to the front of the potty base 8 by means of a snap fastener 16 that engages an aperture 17 located on the themed portion 10.

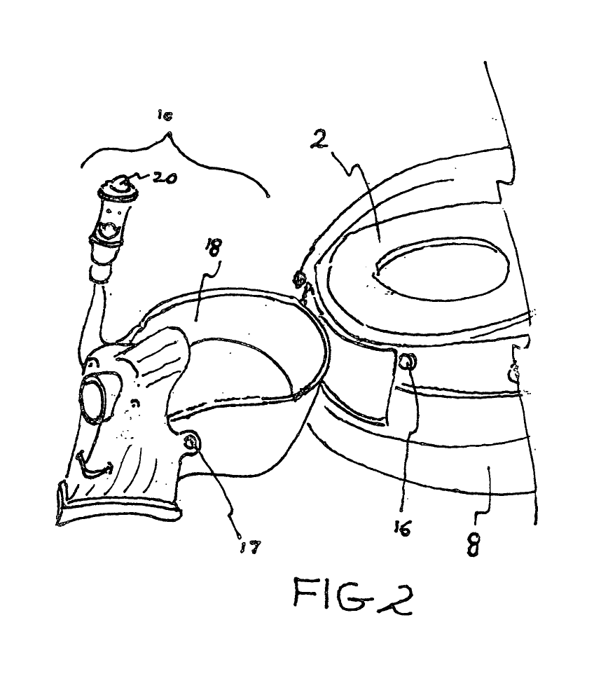

FIG. 2 is an exploded view of the present invention where the front themed portion 10 has been removed, exposing the open topped container 18 that normally resides under the seat portion 2 of the potty chair. This container 18 retains the child's urine or feces and can be cleaned and returned to the potty chair as needed.

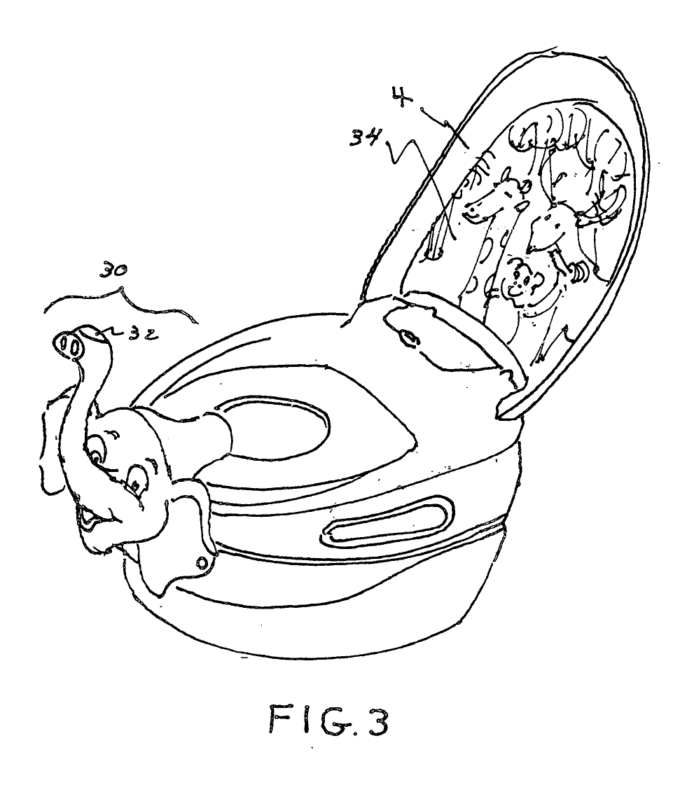

FIG. 3 is a perspective view of the potty chair of the present invention with a jungle theme where an elephant 30 is attached to the front of the chair and by pushing a button on top of the trunk, a trumpeting elephant sound can be heard. A jungle themed graphic 34 is attached to the inside of the lid 4.

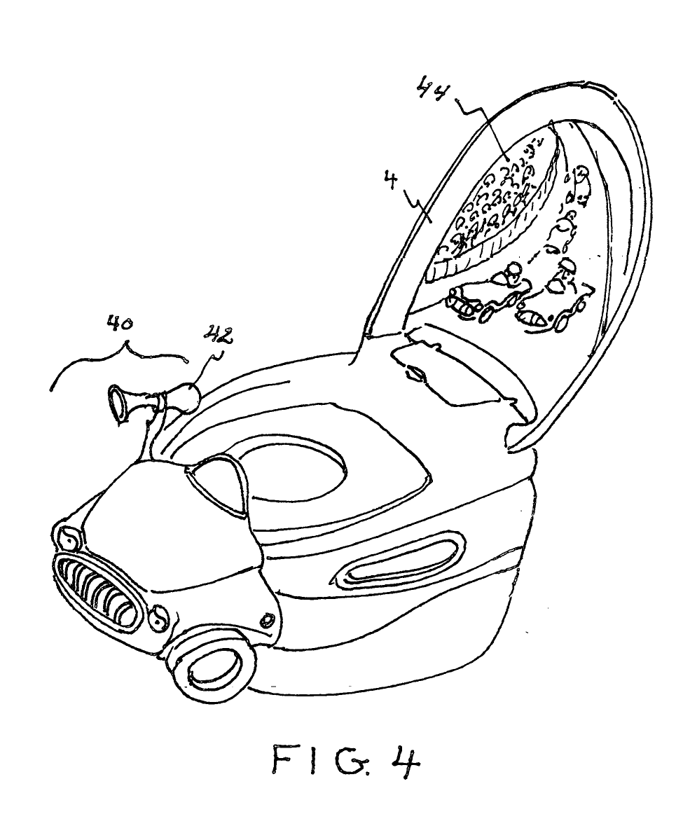

FIG. 4 is an auto themed chair where the front of a racing car 40 is attached to the front of the chair. The car horn 42 can be operated by the child to cause a beeping sound to be emitted. A race car graphic 44 is mounted on the inside of lid 4.

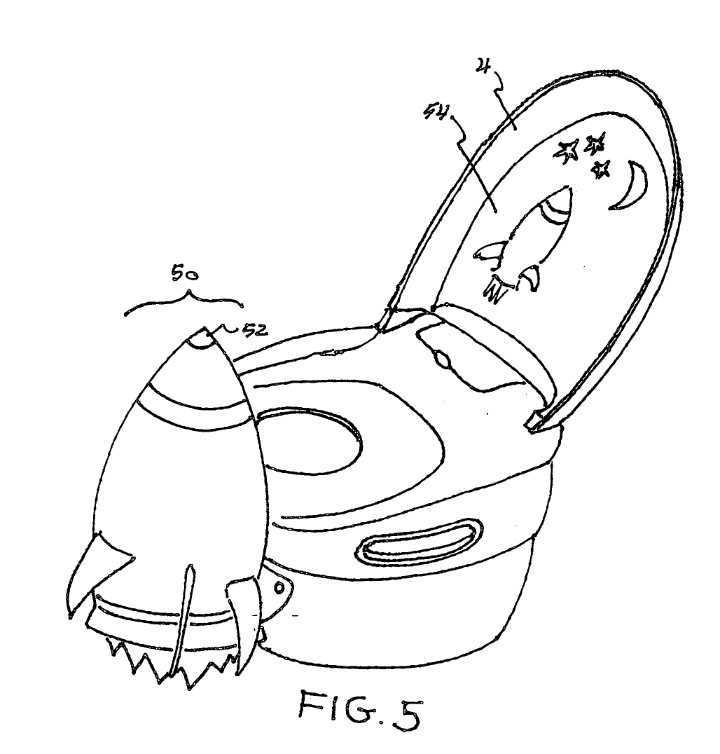

FIG. 5 is a space themed chair where the front themed portion is in the shape of a rocket ship 50. By pressing on the tip of the rocket 52, a rocket propulsion sound can be heard. A space themed graphic 54 is mounted on the inside of lid 4.

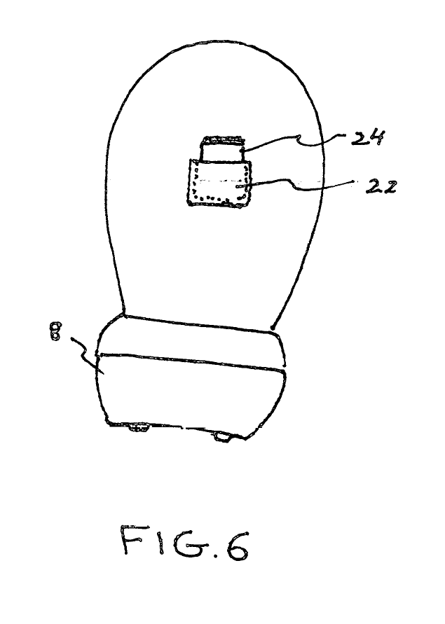

FIG. 6 is a rear view of the potty chair of the present invention. A book holding pocket 22 can retain a story book 24 that relates to the theme of the potty chair. For example, the rocket themed chair can have a story about space travel.

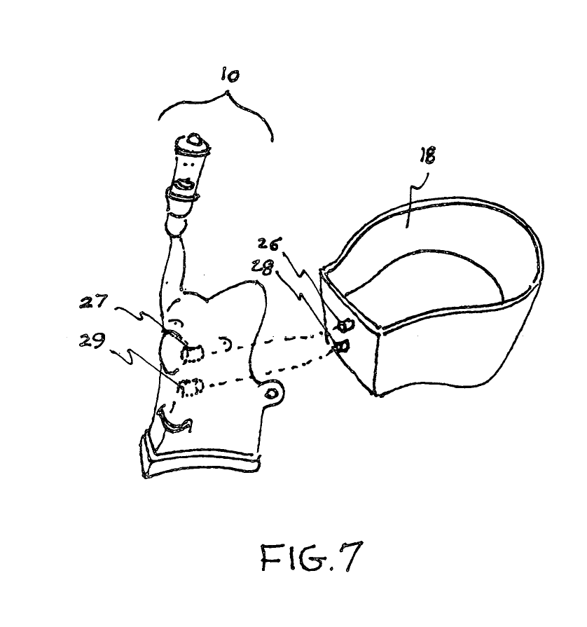

FIG. 7 is an exploded view showing the front themed portion 10 unplugged from the open topped container 18. The themed portion includes sockets shown by dotted lines 27, 29 that frictionally plug onto posts 26, 28. In this way, the user can use a single open topped container and change the themed front pieces 10, 20, 30, 40,50 as so desired.

The above unique themed potty chair allows a parent or care giver to purchase a single potty chair and have the choice of multiple themed fronts and lid graphics to increase a child's interest in continuing to potty train, without having to purchase a new themed chair. The addition of a corresponding story book that can reside in a pocket mounted to the chair further increases the play value of the chair, as well as provides potty training advice in child-relatable text for potty training success, ultimately providing a positive potty training experience for both parent and child.

Expanding on the cost savings component, when the present invention is finished being a used as a potty seat the accessories be removed and the potty chair can act as a step stool for a young person to have access to sink to wash his or her hands. Additionally, the seat portion can be removed and be used on top of the seat of an adult sized toilet to help young children make the adjustment from a potty chair to an adult toilet.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. a potty training device with interchangeable themes comprising:
a standard potty seat;
a potty lid;
an open topped container;
a themed front portion;
a book holding pocket; and
a themed graphic;
said potty lid hinge attached to said standard potty seat;
said open topped retainer capable of being slidably received through an aperture in said standard potty seat so that said open topped container resides directly under said potty seat;
said themed front portion removably attached to the front portion of said standard potty seat;
said graphic panel removably attached to the inside surface of said potty lid;
said book pocket fixedly attached to the outer surface of said standard potty seat;

2. A potty training device with interchangeable themes as claimed in claim 1 wherein said removable and replaceable themed front portion includes an audio device that can be operated by the user and can be programmed to correspond to said theme of said potty training device.
